(19) United States
(12) Patent Application Publication
(10) Pub. No.: US 2012/0304524 A1
(43) Pub. Date: Dec. 6, 2012

(54) LURE

(76) Inventor: Sergei Vladlenovich Ulianov, Dniepropetrovsk (UA)

(21) Appl. No.: 13/578,409

(22) PCT Filed: Apr. 20, 2010
(86) PCT No.: PCT/UA10/00020

§ 371 Date: Aug. 10, 2012

(30) Foreign Application Priority Data
Mar. 25, 2010 (UA) A 2010 03485

(51) Int. Cl. A01K 85/00

(52) U.S. Cl. 43/42.09; 43/42.49; 43/42.39; 43/42.34

(57) ABSTRACT

The invention relates to fishing, in particular, artificial baits, namely, the oscillating lures, and can be used by amateur fishermen while fishing. The lure comprises the elongated body with a weight, an opening for attaching a fishing line and at least one hook. The front, lower or tail portion of the body is provided with a plate holder having a ring at the end, said ring passing with a gap through two openings which are divided by a crosspiece and are arranged in the middle part of the plate on the vertical or horizontal axis at equal proximity to the center of symmetry thereof. The lateral portions of the plate are symmetrically convex (curved) relative to the vertical axis. The plate is fastened in an articulated manner to the ring and can be inclined in different planes from a central position perpendicular to the longitudinal axis of the lure, with the convex (curved) lateral portions of the plate being pointed forward in the direction of the lure movement. The result is a lure that works very effectively and carries out its function at a minimal execution rate, with a wide range of oscillations, namely, from aggressively vibrating oscillations with a high frequency and low amplitude to the oscillations working more gently and at a low frequency with an increase in the oscillation amplitude and without tangling the fishing line around the hook, and which would have ability of providing effective oscillations under condition of changing direction and speed of movement.

The invention relates to fishing, in particular, artificial baits, namely, the oscillating lures, and can be used by amateur fishermen while fishing.

It is known that some species of freshwater predatory fish, such as, for example, perch and pike perch, prefer baits creating high-frequency oscillations. Such oscillations are generated by well known types of lures: rotational lures, plastic and silicone lures including, inter alia, Twister Lures and Vibrotail Lures. However, these baits create smoothed and high-frequency oscillations, which in some cases, depending on fishing conditions, are neither sufficiently attractive to a predator, nor, being insufficiently intensive, spread by the bait to the required distance and remain undetectable for a predator.

Based on the above said information, there were designed several types of artificial lures being able to create high frequency vibrations and intensive oscillations of vibration nature. These lures include, for example, wobbler Rattlin, that is, a three-dimensional plastic fish without a nose blade wherein a flattened back is usually provided with a device for attaching a fishing line [ [symbol] [symbol] - [symbol] [symbol] [symbol] - [symbol] [symbol] 2003, c. 134,142]. (Shcherbakovs Brothers—Modern Spinning, Moscow—Ast-Astrel Guardian, 2003, pages 134.142)].

At horizontal leading or lifting up, such lures tremble and twitch creating high-frequency oscillations. At the same time, because of the fact that the vibrations are generated in the process of streamlining just a flattened upper surface of wobblers with oncoming flow of water, when lowering onto the bottom, these lures do not vibrate, and this event becomes a hindrance to effective application of the lures at fishing with the use of such a common method of fishing as jigging whereat the lures periodically rises from the bottom and then lowers down to the bottom, attracting predators at the moment of lowering. In addition, since the oscillations are performed by the three-dimensioned streamlined body of the lure, in some cases, the power and sharpness of these oscillations are not very effective. Because of the three-dimensional body of the lure and its volume to weight ratio, the use of the above mentioned lure can be complicated in the pools of great depth and current. At the same time, because of the fishing line attachment to the body, which is itself considered as an oscillating element of the lure, the design and the properties of a fastener used to attach the fishing line are of essential importance.

Since the oscillations are directly generated by body Rattlin, changing the nature of those oscillations can not be provided without a significant change in the lure design as a whole, which fact, in essence, should be considered as developing a new model and accompanied by the necessity of manufacturing new expensive equipment. In addition, design Rattlin itself in the form of bladeless wobblers makes it possible to create models generating sufficiently high frequency oscillations having small amplitude.

The closest analog to the claimed invention is a lure designed to create sharp and high-frequency oscillations, that is a metal Lure-Cicada made in the form of a slightly convex oval metal plate with one or more holes for attaching a fishing line, and with a weight of an elongated round shape located at the front bottom portion of the bait. The plate is connected to the fishing line through the buckle or a small winding ringlet. The Lure-Cicada can be equipped with one or two double Or triple hooks [ [symbol] [symbol] - [symbol] [symbol] [symbol] - [symbol] - [symbol] 2003, c. 144-147 (Shcherbakovs Brothers—Modern Spinning, Moscow—Ast-Astrel Guardian, 2003, pages 144-147)].

At horizontal leading, the above said lure creates sharp and high-frequency oscillations propagating over long distances when the lure moves. The lure is compact, so it can easy immerse to the desired depth. In the process of fishing, frequency and strength of the lure oscillations can be adjusted within certain limits by attaching fishing line to one of several holes in the top of the lure.

With such a sharp and intensive play, the lure is sufficiently attractive to predators, in particular, for a perch and a pike perch. However, the design features of the lure have certain disadvantages.

Thus, the oscillating element, namely, the petal of the lure, is firmly fixed to the weight. Accordingly, to start operating, the lure should be affected with a considerable force sufficient to move not only the oscillating element, but also the lure weight, which is tightly associated with the oscillating element, and depending on the operating conditions, the weight might have a significant mass. Therefore, while horizontal leading, the lure effectively operates at mean- and high-speed of leading. Since the moment of beginning the movement, the lure should achieve the speed, whereat the lure starts Vibrating. In doing so, at a low value of speed being not sufficient for the Lure-Cicada to start operating, it moves almost without oscillations, and attracts no attention of a predator. In addition, since Lure-cicada, which has a streamlined compact body, easy dives, holding it in the upper layers of water is provided due to increasing the speed of leading. Therefore, the effectiveness of the Lure-Cicada application is insufficient for fishing in an environment where the speed of the lure leading is desirable to be reduced to minimum.

Because, like Rattlin, the fishing line is directly attached to the oscillating plate of the lure, with the opposite portion of the plate being rigidly connected to the weight of the lure, Cicada is also considered sensitive to the choice of design and quality of the fasteners applied, which can significantly affect the efficiency of the lure operation.

Owing to the design features, while moving, the elongated petal of vibrating Cicada tends to occupy a position close to the vertical one. In some cases, such an operating position of the lure, whereat the petal acts as a spacer, makes it difficult to complete closing jaws of an attacking predator and to strike it with hooks. The lure has got insufficient catching ability just because of the great number of fish attacks that are not completed with engagement the fish by the hooks.

In addition, the design compactness of the lure results in the fact that all of its functional elements, including the point of the fishing line attachment, hooks and weights, are in close proximity to each other. Such arrangement of the lure design elements also results in its chaotic rotation and, respectively, in frequent lashing the fishing line on the hooks while throwing the lure.

In terms of design features, the Lure-Cicada is intended for creating sharp and high-frequency oscillations, herewith the availability of multiple holes for attaching the fishing line onto the upper edge of the lure can definitely change the nature of the oscillations of the lure, keeping, however, the sharpness and high-frequency of the oscillations. Thus, such a lure design does not allow developing the models creating more gentle and sweeping oscillations, which may be necessary for specific fishing conditions.

The indicated lure, like the previous analogue, is aimed at creating high-frequency and extremely sharp oscillations, and its design does not essentially allow generating models that produce gentle, smooth oscillations, which are required under certain fishing conditions. Taking into account the fact that the Cicada oscillating element is its body, providing the Cicada with such additional attractive elements as brushes, fishcalls, etc., which may increase the effectiveness of the lure operation, results in increasing initial speed of the lure, whereat the Lure-Cicada starts vibrating.

Since the design of the Lure-Cicada provides its vibration only under condition when the lure upper working edge is bypassed with oncoming flow of water, with free sinking to the bottom, the Lure-Cicada, which meets oncoming flow of water by its weight, loses the ability to create the active high-frequency oscillations. This is a drawback for the use of the Lure-Cicada in such a method of fishing as jigging.

The technical problem of the present invention is to create a lure of improved design, which would have high efficiency of operation, performing its function at minimal speed of leading, with a wide range of vibrations, namely, from aggressive oscillations of high frequency and small amplitude to the oscillations working smoother and with less frequency at increasing amplitude and without lashing a fishing line on hooks, and which would have ability of providing effective oscillations under condition of changing direction and speed of movement.

The specified technical problem is solved by developing the lure comprising the elongated body with a weight, an opening for attaching a fishing line and at least one hook, wherein, according to the invention, the front, lower or tail portion of the body is provided with a plate holder having a ring at the end, said ring passing with a gap through two openings which are divided by a crosspiece and are arranged in the middle part of the plate on the vertical or horizontal axis at equal proximity to the center of symmetry thereof, the lateral portions of the plate are symmetrically convex relative to the vertical axis, and the plate is fastened in an articulated manner to the ring and can be inclined in different planes from a central position perpendicular to the longitudinal axis of the lure, with the convex lateral portions of the plate being directed forward—in the direction of the lure movement.

The body can be manufactured flat or three-dimensional, combined, one-piece or compound (assembled), or mounted on a rod or a frame, the front part of which is attached to the weight of the lure. The body of the lure has got additional curved, flat, or combined surfaces in horizontal plane.

The body can have deepening and/or protrusion at its lower portion.

The opening for attaching the fishing line can be made at the top of the body or in the upper portion of the weight of the lure.

In the tail portion of the body, there can be fixed a brush or a soft tail made of fur or synthetic polymeric materials, being united with a hook or executed separately.

The weight can be motionlessly or movably, by one or two hinges, secured in the front or nose portion of the body.

The weight can be performed split, with two lateral portions attached to the body by the bent axle connecting the portions of the weight.

The holder of the plate can be executed separately or as a single unit with the body. It can be attached to the body or to the weight either motionlessly or with the possibility of migrating and fixing at different positions in vertical plane or of rotating about its longitudinal axis at a limited angle.

The holder can be provided with fasteners for its installing and dismantling, it can be performed with the possibility of rotation through limited angle in the vertical or horizontal plane.

The holder of the plate can be made rigid or elastic.

The holder can be made shortened or elongated, convex or straight, with a ring arranged on the holder longitudinal axis, or being shifted forward or backward from the axis, with the additional projections at the point of the holder junction with the ring for limiting the angle of the plate inclination.

The holder can be made in the form of a bar, contour, frame, plate.

The ring can be executed either together as a single unit with the holder, or separately from the plate holder. It may be solid or split, or with a fastener for breaking, which is made of a round, oval, elongated shape, with one end being rounded, and with its other end being angled, or in the form of a segment, or at least with one straight inner edge, or with the inner edge having a protrusion, or it has the extended free end, or the protrusions for limiting the angle of the plate inclination.

The plate having two axes of symmetry may be performed of a circular, square, rectangular, oval shape, the shape of two semicircles joined by straight or curved lines, or it has any of the mentioned shapes, wherein some amount of the straight lines are replaced with the curved lines, and vice versa, or with rounded corners, or it is manufactured of a combined form with vertical or vertical and horizontal axes of symmetry

The plate can be made elongated and located with its longitudinal axis in the horizontal or vertical plane.

The plate can have the lateral edges, which are symmetrically convex relative to the vertical axis, and a flat middle portion, or the lateral surfaces, which are symmetrically fully or partially convex relative to the vertical axis, with a different shape, angle, radius of curvature, or the plate can have a symmetrical curvature relative to the vertical axis, and it can be symmetrically or asymmetrically curved in the same direction relative to the horizontal axis, or the side of the plate can have curved portions with deepening in working surface at the area of location of the openings with the crosspiece, or along its vertical axis.

The plate curvature can be performed of a cylindrical, spherical, faceted, tapered, and combined form. The plate curvature can be made of variable radius, with combination of symmetrically curved and flat surfaces, with different ratio of flat and curved surfaces.

The openings with the crosspiece on the plate can be made by setting the crosspiece transversely to the elongated slot in the plate, or by performing two openings in the plate with an interval between them being necessary to form a crosspiece.

The openings in the plate can be executed both circular and elongated in the horizontal plane, with their symmetrical arrangement relative to the plate vertical axis of symmetry.

The crosspiece is executed coinciding with the surface of the plate or projecting with respect to the plate in the direction of the back side of the plate.

The ring can be brought into the position in front of the lure body with approach to the longitudinal axis of the lure or with displacement downward, or into the lower portion of the body separately or with fractional deepening into the lure body.

The plate can be attached to the holder either behind or in front of it.

The body and the plate can be made of metal, synthetic, plastic, organic materials, or their combinations.

Due to the fact that the oscillating plate of the lure is not connected rigidly to its body and weight, the above said plate starts oscillating with high frequency just since the moment whereat the lure is brought into motion, that is, the lure performs its function at leading with minimum speed. In addition, this design feature allows, without any prejudice to the oscillating properties of the lure, attributing its body with such additional attractive elements, as a soft tail, brush, etc., increasing the efficiency of the lures operation under certain conditions.

Since the oscillating plate of the lure is pivotally attached to the holder at the point that is close to the said plate center of symmetry, and the said plate is able to move in different planes relative to this point, at any arrangement of the lure body in the space, the plate tends to maintain its position, at which the plate vertical axis is perpendicular to the oncoming flow of water, that is, there is created the most effective position for oscillations. In addition, the performance capacity of the lure is kept even in the case of some displacement of the openings relative to the center of symmetry along the vertical axis, or under the condition of some violation of the symmetry for the curvatures of the plate sides. With sharp changing a direction of the lure movement, the plate adjusts its position relative to the oncoming flow of water without interrupting the oscillations.

Compared with the prototype, in which the oscillations are generated by oncoming flow of water onto the forward edge of the petal, such oscillations are not occurring at the moment of a lure free descent onto the bottom, according to the claimed invention, while applying the lure of the claimed design, the oncoming flow continues to communicate with the working surface of the oscillating plate even at the moment of the plate free descent onto the bottom. Thus the nature of the oscillations, which are structurally specified for this model, is not changed.

Unlike the prototype, wherein the oscillating element is immediately the lure body, and which efficiency of oscillations can be influenced by the manner of attaching the fishing line, as well as a design and quality of the fasteners, in the claimed lure, the oscillating plate has structurally specified hinged joint in the form of a ring ensuring its oscillations irrespective of the body, thus the ability of the plate to perform the oscillations does not depend on the manner of attaching the body to the fishing line, therefore, the way of attaching a fishing line to the lure does not affect the efficient operation of the lure.

In the prototype, the point of attaching the fishing line, the weight and the hooks are located in close proximity to each other, and the claimed design of the lure provides an extended body, wherein the hooks are fastened to the distance from the point for attachment of the fishing line and the weight, so the lure does not tend to tangling the fishing line around the hooks, as it usually occurs in the prototype.

In the process of leading, in the flow of water, unlike the prototype wherein the lure tends to occupy a position close to the vertical one, the body of the lure, while performing its uniform motion, continues to remain in horizontal plane, not hindering fish linkage by the hooks at attacks.

Taking into account that the design of the lure after the invention provides for the availability of the oscillating element, namely, the plate, which operates separately from the body of the lure and is attached to the body with the help of the holder having a ring, the vibrations and oscillations of the plate are transmitted to the body of the lure through the holder having a ring fixed at the holder end and being motionless with respect to the holder, which holder and ring in this case perform the function of the lever transmitting the oscillations of the plate to the body of the lure that also starts oscillating with the frequency of the plate oscillations and with greater amplitude. Thus, changing in the body load or in its weight, due to applying additional constructive elements to the lure, does not affect the ability of the plate to perform the structurally specified oscillations or vibrations, including under conditions of sharp changing the direction of the lure movement or at lowering it onto the bottom.

In addition, the design allows, without any structural changes, additional costs and any supplement processing equipment, solely by changing only the shape and curvature of the plate, to create a lure of a wide range of oscillations, namely, from the lures operating with aggressively vibrant oscillations of high frequency and small amplitude to the lures operating more gentle and less frequently with increasing amplitude, as well as the lures, which are capable, depending on the speed of leading, to wobble with an amplitude up to several centimeters.

Moreover, when using the same component parts, at the expense of application of the ring connecting to the plate through the holes on the plate horizontal axis of symmetry, the lure produces more active and sweeping oscillations. When applying the ring, which is vertically connected to the plate, the lure produces the oscillations of higher frequency and smaller amplitude. At applying the plates of the same size, but of the different characters of the symmetrical curvatures relative to at least vertical axis of symmetry for the plates, the lure substantially changes the character of the oscillations, namely, from the oscillations of high frequency and small amplitude, while applying the plate having the flat middle portion and the curved lateral portions, to the oscillations of mean frequency and with larger amplitude, while applying the plate having significant curvatures of the lateral portions and with the absent or minimal flat surface in its middle portion.

The use of the elongated plate with the full smooth curvatures of the lateral surfaces located in front of the body of the lure and attached to the body with the horizontal arrangement of the longitudinal axis makes it possible to create the lure, which is capable at the minimal speed to produce the smooth oscillations having the large amplitude, which are swinging from side to side in the course of the movement.

The use of the plate located in front of the lure body or at its lower front portion allows creating the lure with the sharp oscillations and vibrations providing for the lure body swinging with a significant amplitude resulting in smoothing the character of the oscillations of the lure as well as in decreasing the amplitude of the body oscillations during the lure operation, while arranging the plate in the middle of the body or behind the same.

The invention is illustrated with the following drawings.

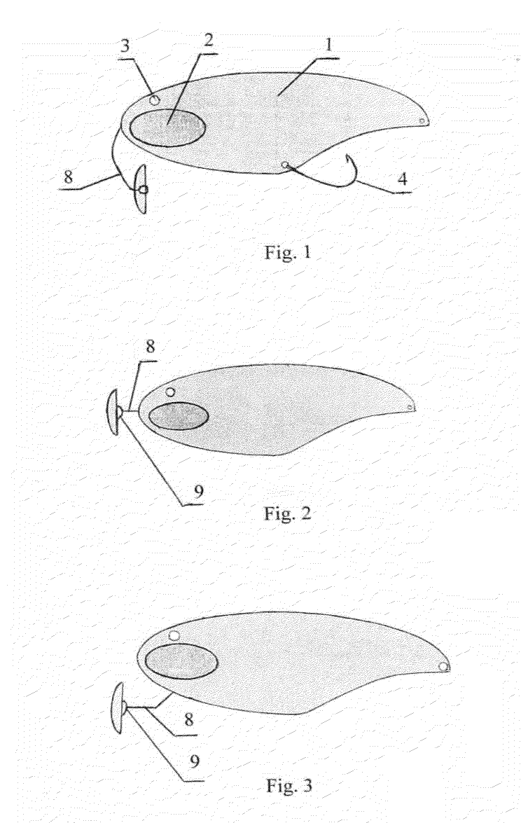

FIG. 1 shows the lure with an elongated lure holder fastened in front of the lure body;

FIG. 2 shows the lure with a short holder fastened in front of the body;

FIG. 3 shows the lure with an elongated holder fastened to the lower portion of the body;

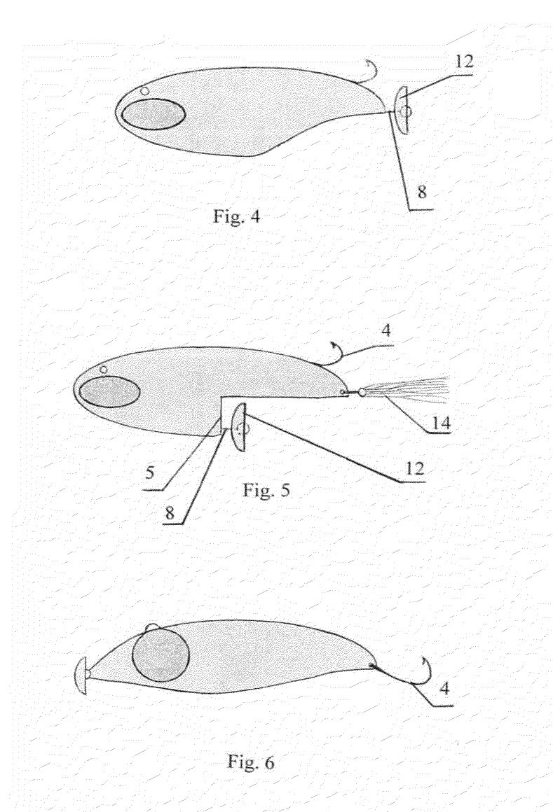

FIG. 4 shows the lure with a short holder fastened at the tail portion of the body;

FIG. 5 shows the lure with a short holder fastened in the recess of the lower portion of the body;

FIG. 6 shows the lure with a holder performed at one with the body as its projecting nose portion;

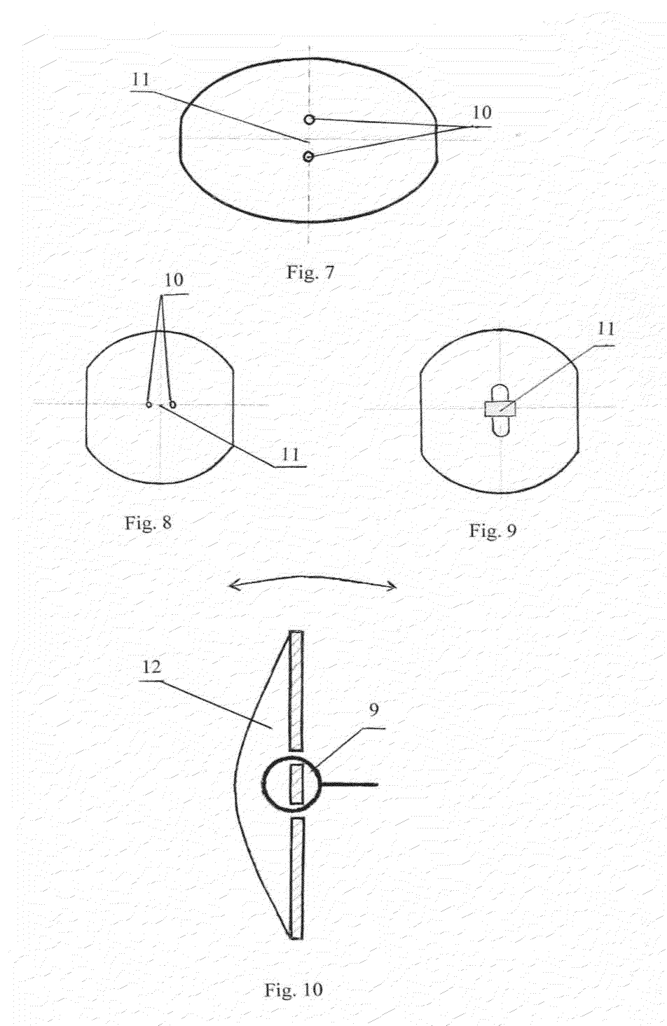

FIG. 7 shows the front view of the plate being elongated in the horizontal plane with the openings that are performed on its vertical axis of symmetry;

FIG. 8 shows the front view of the plate with the openings performed on its horizontal axis of symmetry;

FIG. 9 shows the front view of the plate with the crosspiece installed transversely to the elongated slot in the plate;

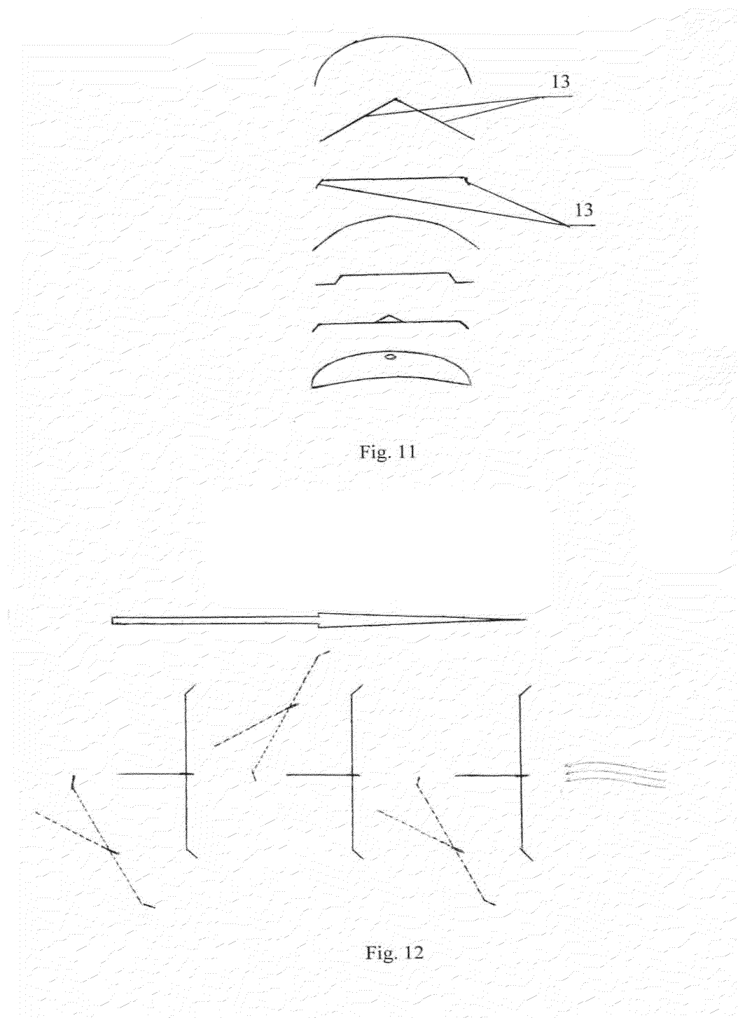

FIG. 10 shows the side view of the plate with the openings performed on the vertical axis of symmetry;

FIG. 11 shows the form embodiments of the plate;

FIG. 12 shows the trajectory of the movement for the plate with the openings arranged on the vertical axis of symmetry;

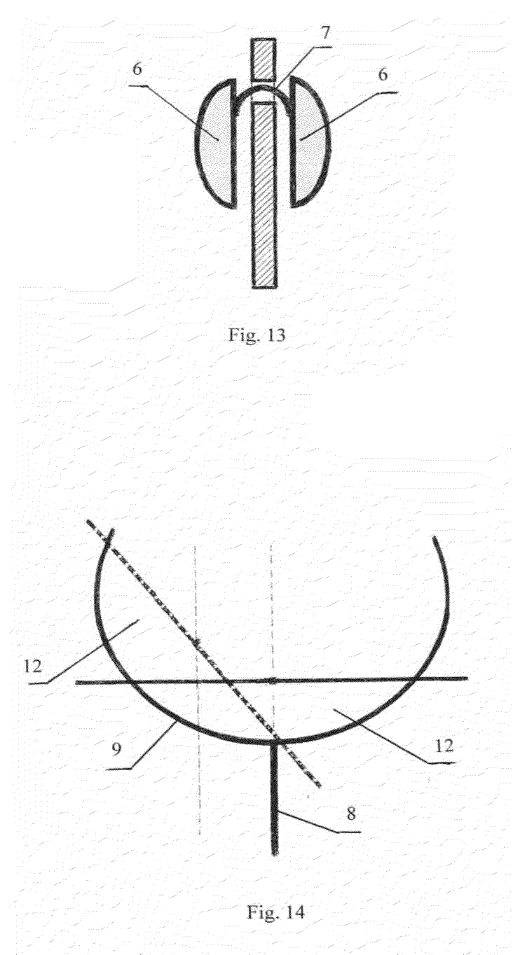

FIG. 13 shows the split weight being fixed with a bent axle;

FIG. 14 shows the plate with the ring located on the horizontal axis of symmetry as well as its inclination from the axis of the motion at turning.

The lure comprises elongated body 1 having weight 2, opening 3 for attaching a fishing line and at least one hook 4.

Body 1 can be manufactured flat or three-dimensional, combined, one-piece or compound (assembled), or mounted on the rod or the frame, the front part of which is attached to the weight of the lure. The body of the lure can have additional curved, or flat, or combined surfaces in the horizontal plane. Body 1 can comprise deepening and/or protrusion 5 at its lower portion (FIG. 6).

Weight 2 can be motionlessly or movably secured in the front or nose portion of the body by one or two hinges. The weight can be performed split (FIG. 13), with two lateral portions 6 attached to the body by bent axle 7 connecting the portions of the weight.

Opening 3 for attaching the fishing line can be made at the top of body 1 or in the upper portion of weight 2 of the lure.

In the front portion (FIG. 1, FIG. 2), or lower portion (FIG. 3), or tail (FIG. 4) portion of body 1, there is performed holder 8 with ring 9 at the end. Ring 9 is threaded with a gap through two openings 10 divided by crosspiece 11 and arranged in the middle part of plate 12 on its vertical axis (FIG. 7) or horizontal axis (FIG. 8), with equal approach to its center of symmetry.

Lateral portions 13 (FIG. 13) of plate 12 are symmetrically convex relative to the vertical axis, and they also can be convex relative to the horizontal axis. Plate 12 is pivotally attached to ring 9, and it is executed with the possibility of inclining in different planes from the middle position being perpendicular to the longitudinal axis of the lure, in which position curved side portions 13 being pointed forward in the direction of the lure movement

Having two axes of symmetry, plate 12, may be performed of a circular, square, rectangular, oval shape, the shape of two semicircles joined by straight or curved lines, or it has any of the mentioned shapes, wherein some amount of the straight lines are replaced with the curved lines, and vice versa, or with rounded corners, or it is made of a combined form, with vertical or vertical and horizontal axes of symmetry

Plate 12 can be made elongated and arranged with its longitudinal axis in the horizontal or vertical plane.

Plate 12 can have the lateral parts, which are symmetrically convex relative to the vertical axis, and a flat middle portion, or the lateral parts, which are symmetrically fully or partially convex relative to the vertical axis, with a different shape, angle, radius of curvature, or the plate can have a symmetrical curvature relative to the vertical axis, and it can be symmetrically or asymmetrically curved in the same direction relative to the horizontal axis, or the side of the plate can have the curved portions with deepening in the working surface at the location of the openings with the crosspiece or along its vertical axis (FIG. 11). Plate 12 curvature can be performed of a cylindrical, spherical, faceted, tapered and combined form. The plate curvature can be made of variable radius, with combination of symmetrically curved and flat surfaces, with different ratio of flat and curved surfaces.

Plate 12 can be attached to the holder either behind or in front of it.

Openings 10 with crosspiece 11 on plate 12 can be made by setting crosspiece 11 transversely to the elongated slot in plate 12 or by performing two openings in the plate, with an interval between the openings that is necessary to form the crosspiece.

Openings 10 in the plate can be executed both circular and elongated in the horizontal plane, with their symmetrical arrangement relative to the plate vertical axis of symmetry which fact provides for increasing the amplitude of plate 12 oscillations in the horizontal plane.

Crosspiece 11 between the openings of the plate can be performed either by executing two openings at some distance from each other, or by making an elongated opening with additional installation of a separate crosspiece being transverse to the middle portion of the elongated opening.

Crosspiece 11 is executed coinciding with the surface of plate 12 or projecting with respect to the plate in the direction of the back side of the plate.

Body 1 and plate 12 can be made of metal, synthetic, plastic, organic materials or their combinations.

Holder 8 of plate 12 can be executed separately or as a single unit with body 1. It can be attached to body 1 or to weight 2 either motionlessly or with the possibility of migrating and fixing at different positions in vertical plane. Holder 8 can be made rigid or elastic. Holder 8 is provided with fasteners (not shown) for its installing and dismantling. Holder 8 can be made with the possibility of rotation through limited angle either in vertical plane or in horizontal plane. Holder 8 can be made either elongated (FIG. 1, FIG. 3) or shortened (FIG. 2, FIG. 4, FIG. 5), either curved (FIG. 1, FIG. 3) or straight (FIG. 2, FIG. 4, FIG. 5), with the ring either located on the holder longitudinal axis or being shifted forward or backward from the axis, with the additional projections (not shown) at the point of the holder junction with ring 9 for limiting the angle of the plate inclination. Holder 8 can be made in the form of a bar, contour, frame, plate.

Ring 9 can be executed either together as a single unit or separately from holder 8. It may be either solid or split, or with a fastener for breaking, which is made of a round, oval, elongated shape, with one end being rounded, and with its other end being angled, or in the form of a segment, or at least with one straight inner edge, or with the inner edge having a protrusion, or it has the extended free end or the protrusions for limiting the angle of the plate inclination.

Ring 9 can be brought in front of the lure body 1 with approach to the longitudinal axis of the lure, or with displacement downward, or into the lower portion of the body separately or with fractional deepening, into the lure body.

In the tail portion of body 1, there can be fixed brush 14 or a soft tail made of fur or any of synthetic polymeric materials (FIG. 5) united with a hook or executed separately.

The claimed lure operates as follows.

At the beginning of the uniform motion, oscillating plate 12 attached to body 1 with the help of holder 8 provided with ring 9, which ring 9 with a gap is threaded into the plate through openings 10 arranged on the vertical axis of symmetry of plate 12, in this case, openings 10 are located in the central part at the same distance from the center of symmetry of the plate, and under such a condition, plate 12 is disposed along the vertical axis perpendicular to the oncoming flow of water motion. Since the contact of plate 12 with the inner surface of ring 9 is performed through crosspiece 11 separating openings 10, plate 12, the edges of which are curved toward the direction of the motion, under the influence of the turbulent flow and owing to the gaps between opening 10 and opening 9, (this plate) is inclined to one of the sides in the horizontal plane. Thus remaining perpendicular to the direction of motion in the vertical plane and changing the angle with respect to the oncoming flow of water in the horizontal plane, the plate is displaced aside from the axis of the lure motion. At the same time, through holder 8 of plate 12 and its prolongation, namely, ring 9, which are operating in this case as a lever, plate 12 transmits the effort onto body 1 of the lure, which is also inclined aside from the direction of its movement in the horizontal plane. At locating the plate in the nose portion of the lure, the body rotation is carried out aside and opposite to the direction of the plate inclination. At arranging the plate in the tail portion of the body, the body inclination is carried out in the same direction. In doing so, the body inclination is carried out relative to the point of fixing the fishing line to the body of the lure. Once at an angle to oncoming flow of water, the body is occurred under the force, which additionally starts to incline the body from the direction of the motion. At the moment, when the force of plate 12 impacting on body 1 of the lure is balanced by the force that, being under the influence of oncoming flow of water, is applied to the body being inclined aside, the inclination of the lure body stops, plate 12 changes its angle of attack for the opposite one in oncoming flow of water in the horizontal plane and moves, being displaced by the flow of water, in the opposite direction. In such a case, body 1 of the lure is also inclined to the opposite direction. With above said method of mounting plate 12, providing the frontal orientation of the plate with respect to the oncoming flow of water at sharp changes in direction of the lure in the vertical plane is accomplished by means of assuring the motion of plate 12 relative ring 9, under which condition crosspiece 11 of the plate usually moves over the inner surface of the ring.

Plate 12 that is attached to ring 9 through openings 10 located in the middle of the plate on the horizontal axis of symmetry with equal distances from the center of symmetry, under condition of the lure uniform motion, also takes the position, at which the vertical axis of the plate is perpendicular to the axis of the lure motion. While driving under the influence of the water flow turbulence, plate 12 is rotating in the horizontal plane with changing its angle relative to the oncoming flow of water, and the plate, via holder 8 with ring 9, which are acting as a lever, transmits the force to body 1 of the lure, which in this case is inclined from the axis of its motion in the horizontal plane. In addition, plate 12 attached to ring 9 through the openings on its horizontal axis, while turning, is displaced by the flow of water and moves over the inner surface of ring 9 from the middle portion to the lateral portion of ring 9. In the course of additional inclination from the axis of the lure motion, compared to the plate of the vertical attachment, plate 12 of the horizontal attachment transfers more force to body 1 of the lure, which body is also inclined for greater distance from the axis of the lure motion than the plate of the vertical attachment to the ring. Thus, while moving, the lure with the horizontal attachment of ring 9 produces oscillations of greater amplitude than the lure with the vertical attachment. The gaps between plate 12 and ring 9 provide the frontal position of such a plate in the oncoming flow of water at sharp changes in direction of the lure motion in the vertical plane.

While leading the lure, the process of oscillation for plate 12 and body 1 of the lure is performed steadily and continuously.

Regardless of the method of the plate attachment, in the case of the lure motion upward, as a result of a fishing line tension, body 1 with attached holder 8 of the plate is directed upwards, being guided in a space in such a way that its longitudinal axis does not coincide with the changed direction of the motion, and plate 12, not interrupting oscillations, adjusts its position in space keeping the state of perpendicularity over its vertical plane relative to the oncoming flow of water, and the process of performing the plate oscillations in the horizontal plane continues. In the event of termination of winding a fishing line, the lure starts falling onto the bottom under the force of gravity. Body 1 together with holder 8 rushes down, and the direction of their motion also does not coincide with the longitudinal axis of the lure body. While continuing to oscillate in the horizontal plane, plate 12 changes the angle of its arrangement relative to body 1 of the lure and keeps its position, wherein its vertical plane is perpendicular to oncoming flow of water.

Thus, owing to the plate ability to provide orienting in the oncoming flow of water regardless of the location in space of the body, the lure, which is free to fall onto the bottom or to rise sharply upward, continues to oscillate maintaining constructively specified character of oscillations. This invention feature assures the high efficiency of the lure at the jig fishing technique providing for the phase of lifting lure from the bottom and its free lowering. At the same time, as a predator is attracted by the lure at any phase of the motion, and it attacks the lure just when it is lowering, it is very important to provide effective operation of the lure in the course of the lowering phases.

In addition, the tendency of plate 12, with its vertical axis, to be directed perpendicular to the direction of the oncoming flow of water contributes to the free and smooth descent of the lure, and it also slows down the rate of descent prolonging the phase of lowering and, therefore, prolongs the active phases of the lure operation.

The character of the lure oscillations depends on the shape of the plate curvature.

In fact, as it had been found as a result of testing experimental models of the lure after the invention, plate 12 begins vibrating even when the surface of the plate is flat. However, those vibrations are weak to ensure efficient operation of the lure by bringing into the state of oscillating its body 1 that should create significant oscillations in water. In this case, even a slight curvature of the lateral portions of plate 13 could cause the availability of the oscillations of the sufficient force to ensure the oscillations of the whole lure in general.

So, circular plates with flat middle portions and lateral portions 13, which are curved forward in the direction of the motion, provide vibrations of high frequency and small amplitude of oscillations for the above said lure. While decreasing the area of the mean plane portion of the plate with increasing the area of its curved surfaces, there is occurred changing in the character of the oscillations of the plate and the lure as a whole, resulting in decreasing oscillation frequency and increasing oscillation amplitude.

The use of the circular plate with lateral portions curved forward, wherein the curvature starts from the vertical axis of the plate, provides more gentle oscillations with larger amplitude and lower frequency than the flat plate with curved edges. While applying the elongated plate, which is fully curved and installed on the lure with its horizontal arrangement along the longitudinal axis, the lure, depending on the ratio of the length and width of the plate, begins oscillating with low frequency and rare and deep oscillations, resulting in the lure wobbling from side to side.

Because ring 9 is arranged in openings 10 of the plate with a certain gap, there is provided the possibility of turning plate 12 at a certain angle, which is chosen depending on the method of attaching plate 12 to ring 9.

Thus, at installing plate 12 through openings 10, which are located on the vertical axis, the gap must be large enough to allow plate 12 turning in the horizontal plane during the process of generating oscillations relative to its vertical axis, providing such a maximal angle of the plate inclination, at which plate 12 remains turned to the oncoming flow of water with its operating side having lateral portions 13 curved forward.

The way of attaching plate 12 through openings 10 on the horizontal axis should provide the availability of the gap allowing plate 12, which oscillates in the horizontal plane, also to rotate in the vertical plane, in order to maintain the provisions for its vertical axis to arrange perpendicular to the oncoming flow of water at sharp changing direction of the lure motion in the vertical plane.

Arranging the openings for fixing ring 9 in the middle portion of plate 12 on the horizontal or vertical axis of symmetry of the plate with the equal approach to the center of symmetry of the plate provides for the availability of such a position on the plate vertical axis, wherein it is perpendicular relative to the incoming flow of water. Such a position makes it possible to provide the best use of the flow of water energy for creating the plate oscillations compared with the arrangement of the plate in the flow of water at any other angle in the vertical plane relative to the flow of water that can occur under condition of the axis of symmetry displacement for openings 10 in plate 12.

Arranging the plate relative to the body should be carried out in such a way as to allow unobstructed inclination of the plate in any plane, both at creating oscillations, and at maintaining the plate frontal position relative to the flow of water. So, being occurred in a conventionally defined middle position wherein the surface of the plate of the lure, which is moving in the horizontal plane, is arranged frontally to the oncoming flow of water, and the middle portion of the plate is perpendicular to the longitudinal axis of the lure, in such a position, the plate should have a possibility of unobstructed inclination from this position at the same angle in both directions in the horizontal plane; and such a situation provides the process for generating oscillations of the plate and the possibility for the plate of being inclined in both directions in its vertical plane at certain angles that are structurally specified, allowing the plate at the moment, when the lure is changing direction in the vertical plane, itself to install in the position wherein its (plate's) vertical axis is perpendicular to the oncoming flow of water for providing the possibility of the proper, smooth and trouble-free operation of the lure.

To ensure effective and smooth operation of the lure, there is need in ensuring the movement of plate 12 in such a way that, while rotating, the plate remained turned towards the oncoming flow of water only with its surface having the lateral portions curved in the forward direction. In addition, the possibility of plate 12 free sliding over ring 9 and thus changing the angle of plate 12 inclinations in the vertical plane should be limited so that plate 12, while moving in the oncoming flow of water being changed, was not turned to it with its back side. Otherwise, the plate gets occurred in its extreme position, wherein its back side is occurred turned at an angle to the oncoming flow of water, and the plate gets held in the clamped state in such a position losing the possibility of further movement.

The proper restricting degree of plate 12 free motion can be achieved with the help of the gap between plate 12 and ring 9, by means of the curvature and shape of holder 8 of the plate, whereat the plate, being in extreme positions, continues to remain turned to the oncoming flow of water with its working side having its lateral portions curved forward, or owing to the form and size of ring 9 sliding over crosspiece 11, or because of the designs of body 1 and/or plate 12 wherein the plate is limited in its possibility of over-turning by the design elements of lure body 1 itself, or the holder form, whereat the excessive inclination of the plate is limited by the curved portion of the holder, or specially designed protrusions made on holder 8 or ring 9. In this case, the plate moves relative to the ring till achieving a position, wherein the surface of the plate rests on one of the protrusions on the holder, or on the ring, or onto the lure body, remaining in such its position at the moment when a counter flow of water gets running against the working side of the plate having convex lateral portions.

Of considerable importance is also the point for fixing plate 12 relative to body 1 of the lure. Thus, applying plate 12 placed in front of body 1 of the lure or in its lower front portion allows lure producing sharp oscillations that contribute to the most dramatic oscillations of lure body 1, which have a considerable frequency and large amplitude. Arranging plate 12 in the middle part of body 1 or behind it results in certain softening the character of the lure oscillations and reducing the amplitude of body 1 oscillation. At the same time, the plate, being located in the lower and middle portion of the lure, provides increasing the oscillations of the lure body with respect to its longitudinal axis under condition of non-significant amplitude of the oscillations in the horizontal plane. The most effective oscillations of body 1 are provided at locating ring 9 for fastening plate 12 on holder 8 with the certain distance to the center of the lure mass, allowing holder 8 with ring 9 fixed on it to function as a lever providing for effective transferring the force of oscillations of plate 12 of the lure body. Moreover, the availability of the substantial projection of the plate in front of the lure body results in the excessive yaw at the lure motion, as well as unnatural inclining the lure body nose portion downward at performing the motion.

The aspect of ratio for body 1 and plate 12 depends on the location of plate 12, and it should provide an easy confident direction of the lure movement in the flow of water, whereat body 1 under the condition of inclination confidently returns into the state of the movement in the specified direction. In addition, the ratio of the plate and the body sizes should provide confident orientation of the lure body in the specified direction of the motion at starting the lure movement from any initial position of the lure body.

The proposed decision of the technical problem provides a variety of accommodation options, designs and shapes of holder 8 and ring 9, and of the locations of plate 12 relative to lure body 1, respectively. For example, when arranging ring 9 as an element of the prolongation of the nose portion for body 1, the function of holder 8, which provides the possibility to deflect plate 12 in the vertical and horizontal plane, can be directly executed by the rounded or pointed nose portion of lure body 1, as plate 12 can be rolled over and inclined without encountering against the edges of lure body 1. At the same time, in the nose portion of body 1, there can be installed separate holder 8 of straight or curved form, which should be located behind plate 12. Similarly, the plate can be mounted on the tail portion of body 1, whereat, as a holder, there can be used the protruding portion of the body, or there can be installed a separately performed design element serving as a holder.

At arranging plate 12 partially sunk into body 1 of the flattened lure, the function of holder 8 can be performed by the edge of body 1 having deepening 5, wherein the plate is installed. At the same time, deepening 5 of body 1 should provide for the possibility of plate 12 free motion directed perpendicular to the oncoming flow of water as well as the possibility of changing the angle, at which the vertical axis of plate 12 is perpendicular to the longitudinal axis of body 1 of the lure. Plate 12 can be mounted at the lower portion of body 1 either in a recess, which is specially executed in the body of a flat or combined configuration, or without such a recess, being arranged under the lower edge of flat, combined, or three-dimensional body 1 either on a specially performed, as a holder, protrusion of body 1 or on the separately set holder.

Holder 8 can be made curved at the end, with the ring, whereat there is mounted plate 12. Such holder 8 can be installed on the lower edge of the front portion or the middle portion of body 1, and it can be turned either forward or backward with its curved end. Holder 8, being curved forward, can be also mounted at the nose portion of body 1, and holder 8, being curved backward, can be mounted in the tail portion of body 1. In addition, holder 8 with ring 9 for attaching plate 12, to be installed either in the nose portion or in the tail portion of body 1, can be executed of straight form.

As assembled, the lure comprises plate 12 arranged in front of holder 8 or after the same. The lure design comprising plate 12 arranged behind holder 8 may be preferred under conditions of fishing in the ponds that are overgrown or snagged.

The availability of deepening and protrusions 5 in the lower portion of the lure design provides manufacturing the lures, wherein plate 12 is arranged partially deepened into body 1, which is made flat or combined, with the protruding portion of body 1 performed as holder 8, whereat ring 9 is arranged in such a way that plate 12, when inclined from the position being perpendicular to the longitudinal axis of the lure, was not engaged with the surfaces of lure body 1 at sharp lowering and lifting the lure.

Executing the lure body flat or three-dimensional, combined, one-piece or assembled, mounted on a rod or frame, attached with its front portion to the weight of the lure or having the additional curved, flat or combined surfaces in horizontal plane makes it possible to maintain the depth of the lure immersion, with the lure being in the state of motion.

Hinged connecting of weight 2 to the lure body contributes to more active oscillations of body 1 of the lure as, under such a condition, there is no weight 2 inertia. Accordingly, in this case, there can also be applied plate 12 of smaller sizes, in comparison with the application of body 1 with rigidly fixed weight 2.

The hook can be attached either firmly to the tail portion of the body at its top position or in the lower portion with the possibility of displacement, either in the tail and/or in the middle, and/or nose portions of the body, depending on the point of the plate attachment; and at any position of the hook and the plate, the hook should not prevent the oscillations of the plate.

1. The lure comprising the elongated body with a weight, an opening for attaching a fishing line and at least one hook, wherein the front, lower or tail portion of the body is provided with a plate holder having a ring at the end, said ring passing with a gap through two openings which are divided by a crosspiece and are arranged in the middle part of the plate on the vertical or horizontal axis at equal proximity to the center of symmetry thereof, the lateral portions of the plate are symmetrically convex (curved) relative to the vertical axis, and the plate is fastened in an articulated manner to the ring and can be inclined in different planes from a central position perpendicular to the longitudinal axis of the lure, with the convex (curved) lateral portions of the plate being pointed forward in the direction of the lure movement.

2. The lure according to claim 1, wherein the body is performed either flat or three-dimensional, combined, either one-piece or compound (assembled), or mounted on a rod or a frame, the front portion of which is attached to the weight of the lure, and having additional curved, flat, or combined surfaces in horizontal plane.

3. The lure according to claim 1, wherein the body comprises deepening and/or protrusion at its lower portion.

4. The lure according to claim 1, wherein the openings for attaching the fishing line are made either at the top portion of the body or at the upper portion of the weight of the lure.

5. The lure according to claim 1, wherein in the tail portion of the body, there is fixed a brush or a soft tail made of fur or synthetic polymeric materials, being united with a hook or executed separately.

6. The lure according to claim 1, wherein the weight is secured either in the front portion or in the nose portion of the body, motionlessly or movably by one or two hinges.

7. The lure according to claim 1, wherein the weight is performed split, with two lateral portions attached to the body by the bent axle connecting the portions of the weight.

8. The lure according to claim 1, wherein the holder of the plate is executed either separately or as a single unit with the body, and it is attached either to the body or to the weight, either motionlessly or with the possibility of migrating and fixing at different positions in the vertical plane, or of rotating about its longitudinal axis at a limited angle.

9. The lure according to claim 1, wherein the holder is provided with fasteners for installing and dismantling, and it is performed with the possibility of rotation through limited angle either in vertical plane or in horizontal plane.

10. The lure according to claim 1, wherein the holder of the plate is made either rigid or elastic.

11. The lure according to claim 1, wherein the holder is performed either shortened or elongated, curved or straight, with a ring located either on the holder longitudinal axis or being shifted forward or backward from the axis, with the additional projections at the point of the holder junction with the ring for limiting the angle of the plate inclination.

12. The lure according to claim 1, wherein the holder is performed in the form of a bar, contour, frame, plate.

13. The lure according to claim 1, wherein the ring is executed either as a single unit with the plate holder or separately from the plate holder, being either solid or split, or with a fastener for breaking, which is made of a round, oval, elongated shape, with its one end being rounded, and with its other end being angled, or in the form of a segment, or at least with one straight inner edge, or with the inner edge having a protrusion, or it has the extended free end, or the protrusions for limiting the angle of the plate inclination.

14. The lure according to claim 1, wherein the plate having two axes of symmetry is performed of a circular, square, rectangular, oval shape, the shape of two semicircles joined by straight or curved lines, or it has any of the mentioned shapes, wherein some amount of the straight lines are replaced with the curved lines, and vice versa, or with rounded corners, or it is performed of a combined form with vertical or vertical and horizontal axes of symmetry

15. The lure according to claim 1, wherein the plate is made elongated, and it is located with its longitudinal axis being in the horizontal Or vertical plane.

16. The lure according to claim 1, wherein the plate has the lateral edges, which are symmetrically curved relative to the vertical axis, and the flat middle portion or the lateral surfaces, which are symmetrically fully or partially curved relative to the vertical axis, with a different shape, angle, radius of curvature, or the plate has symmetrical curvature relative to the vertical axis, and it is symmetrically or asymmetrically curved in the same direction relative to the horizontal axis, or the side of the plate has curved portions with deepening in the working surface at the area of location of the openings with the crosspiece, or along its vertical axis.

17. The lure according to claim 1, wherein the plate curvature is performed of a cylindrical, spherical, faceted, tapered, and combined form, and also the plate curvature is made of variable radius, with combination of symmetrically curved and flat surfaces, with different ratio of flat and curved surfaces.

18. The lure according to claim 1, wherein the openings with the crosspiece on the plate are performed either by setting the crosspiece transversely to the elongated slot in the plate or by providing two openings in the plate with an interval between them being necessary to form a crosspiece.

19. The lure according to claim 1, wherein the crosspiece is executed coinciding with the surface of the plate or projecting with respect to the plate in the direction of the back side of the plate.

20. The lure according to claim 1, wherein the ring is brought into the position either in front of the lure body, with approach to the longitudinal axis of the lure or with displacement downward, or into the lower portion of the body separately, or with fractional deepening into the lure body.

21. The lure according to claim 1, wherein the plate is attached to the holder either behind or in front of it.

22. The lure according to claim 1, wherein the body and the plate are made of metal, synthetic, plastic, organic materials, or their combinations.

23. The lure according to claim 1, wherein the openings in the plate are executed either circular or elongated in the horizontal plane, with their symmetrical arrangement relative to the plate vertical axis of symmetry.
